(19) United States
(12) Patent Application Publication
(10) Pub. No.: US 2011/0319098 A1
(43) Pub. Date: Dec. 29, 2011

(54) METHOD AND SYSTEM FOR PROVIDING PODCAST INFORMATION USING GEOLOCATION (LBS) INFORMATION

(75) Inventors: Martin C. Potorny, Batavia, IL (US); David A. Jones, Orland Hills, IL (US); Steven M. Welsh, Aurora, IL (US)

(73) Assignee: Alcatel-Lucent USA Inc.

(21) Appl. No.: 12/821,685

(22) Filed: Jun. 23, 2010

(51) Int. Cl. H04W 4/02; H04W 24/00; G06F 21/20

(52) U.S. Cl. 455/456.2; 455/456.3; 726/29

(57) ABSTRACT

A method and system creating a network architecture to allow wireless subscribers to selectively integrate a network of available podcast information which may include podcasts and various other media rich IP-data, and related to locally available information, is provided. Interrogation of the network and/or retrieval and control of such podcasts may be accomplished in realtime or at a specifiable future time. In addition, other subscriber configurable profiles are provided in a variety of forms to further facilitate interrogation, filtering, and retrieval.

### FIELD

This application relates to a method and apparatus for providing podcast information, which may include media rich-data, to a device.

### BACKGROUND

By way of background, there are no known systems that provide podcast-type information to users or subscribers based on geolocation and/or temporal parameters. Podcasts are available for direct downloading or through software applications; however, in those known techniques, podcasts are not provided based on a detected location of a subscriber or at a particular time specified by the subscriber.

Mobile handsets with Internet web searching capabilities allow subscribers to search for Location-Based Service (LBS) information, via mobile telecom or WiFi hot spot location determination. However, these techniques do not provide podcasts based on the location information or temporal information.

### SUMMARY

A method and apparatus for providing podcast information and/or media IP-data using geolocation (LBS) information are provided.

In one aspect, the system comprises a podcast server operative to receive a request from the subscriber device or network to provide podcast information to the subscriber device, validate the subscriber device, obtain location information for the subscriber device, and provide the podcast to the subscriber device based on the location information.

In another aspect, the system further comprises a profile server operative to store subscriber information access by the podcast server.

In another aspect, the subscriber information comprises subscriber preferences.

In another aspect, the system further comprises a location-based services server operative to provide requested location information to the podcast server.

In another aspect, the location information comprises mapping information provided to the subscriber device for viewing.

In another aspect, the mapping information is three-dimensional mapping information.

In another aspect, the podcast server comprises a relational database including information on destination points and corresponding location information on the destination points.

In another aspect, the podcast server comprises a podcast storage module having stored therein podcast data.

In another aspect, the podcast server comprises an interface module operative to allow at least one of short message communications, information sharing, subscriber voting, blogging, and interaction with other subscribers.

In another aspect, the podcast server is further operative to provide the podcast information to the subscriber device based on temporal information.

In another aspect, a method comprises receiving a request from the subscriber device to provide podcast information to the subscriber device, validating the subscriber device, obtaining location information for the subscriber device and providing (e.g. germane and, in one form, local) podcast information to the subscriber device based on the location information.

In another aspect, the method further comprises sending the request from the subscriber device.

In another aspect, the subscriber device is one of a mobile phone, personal mobile device, PDA, mini-computer, smart phone, or pager.

In another aspect, the validating comprises accessing a podcast profile server.

In another aspect, the obtaining of location information comprises accessing a location based services (LBS) server,

In another aspect, the obtaining of location information comprises using Global Positioning System (GPS) information or LBS determination using trilateration between cell sites.

In another aspect, the providing of the podcast information comprises accessing a database having stored therein podcast information and corresponding location information.

In another aspect, providing the podcast information to the subscriber device is further based on temporal information.

In another aspect, providing content based on the location information comprises delivering content upon detection of the subscriber device in a selected sub-location, wherein the sub-location is tagged for such delivery or defined in a user specified table.

In another aspect, the method is implemented using suitable means.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

Some embodiments of apparatus and/or methods in accordance with embodiments of the present invention are now described, by way of example only, and with reference to the accompanying drawings in which:

FIG. 1 is a block diagram of an example of he presently described embodiments;

FIG. 2 is a block diagram of an example of the presently described embodiments;

FIG. 3 is a block diagram of an example of the presently described embodiments;

FIG. 4 is a block diagram of an example of the presently described embodiments; and,

FIG. 5 is a flow chart illustrating an example method according to the presently described embodiments.

### DETAILED DESCRIPTION

According to the presently described embodiments, a method and/or system provide Mobile Telecommunications Networks (and other wireless systems, e.g. WiFi, content delivery technologies) with an advantageous technique to deliver Podcast information/ content to subscribers based on geolocation information (e.g. LBS- Location Based Services). The podcast information contemplated herein generally relates to podcasts or recorded narratives (and/or other related media content including various media rich content such as audio content, visual content, audio+visual content, graphical content, text, and/or enhanced hyperlinked text, etc.) that may be downloaded by a user to a user device from a source, such as a website or the like, for playback at the convenience of the user. It should be noted that, in at least one form, playback is not necessarily a start-to-finish experience for the user, but may be implemented as a throttled delivery having increased context sensitivity within sub-perimeters or sub-locations. The sub-locations, sub-perimeters or zones may be tagged, in one form, within the media. The sub-perimeters, sub-locations or zones may then be detected by the network with respect to user geolocation, or invoked using a manually generated, or user specified, table of content so that content can be precisely delivered to the subscriber device as the subscriber device progresses to very specific locations, e.g. within a gallery, . . . etc. Additionally, in at least one form, a capability is provided which enables subscribers to specify delivery of such material on a temporal basis. For example, content may be delivered (or searched and/or retrieved) at a time in the future—when the subscriber will be at another location (or the same location if applicable), and will be seeking podcast (realtime, or pre-recorded) information/media.

According to the presently described embodiments, in at least one form, a network architecture is created to allow wireless subscribers—at anytime and anywhere—to interrogate the network for podcasts or podcast information available on local information. In at least one form, subscriber configurable profiles facilitate such operation. All of this functionality is, in at least one form, provided with standards-based network elements, signaling, protocols, IW Interworking interface architectures, etc. adapted to achieve the presently described embodiments.

To illustrate the presently described embodiments by way of merely just one example, a museum tour participant having a subscriber device should be considered. Using the presently described embodiments, upon activating the system via a request, the system suggests that certain podcast information is available to a subscriber given the location of the subscriber device. If interested, the subscriber may select the content. Further, in one form, the system may further determine that the subscriber is within a specific sub-perimeter or sub-location based on a content tag (automatic)/table of content (manual) to allow for more refined delivery. In either case, the content or podcast information is delivered and the media is started. In the example, the audio delivery highlights the subtle use of color in a piece of artwork in the first gallery at the museum. As the subscriber continues to listen to the audio, it advises the subscriber to look at the subscriber device where other similar examples from other artists may be viewed. The subscriber may also pause the audio and view several other examples of other artists's similar usage of color. Perhaps later in the tour, the artwork demonstrates the use of geometry in an abstract nature, and the audio advises more about the actual geometry in graphical form is available by viewing the subscriber device. This example illustrates the flexibility and granularity that is realized by the presently described embodiments.

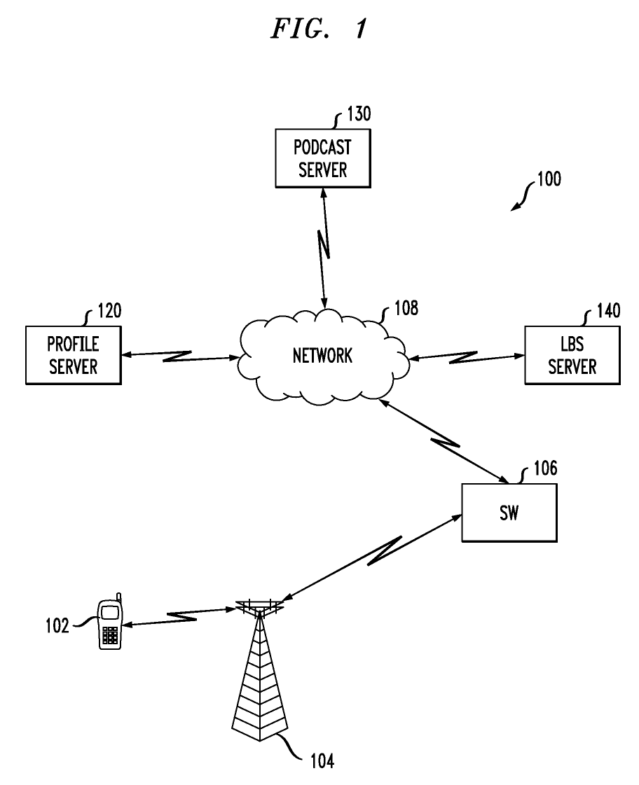

Referring now to the drawings wherein the showings are for purposes of illustrating the exemplary embodiments only and not for purposes of limiting the claimed subject matter, FIG. 1 provides a view of a system into which the presently described embodiments may be incorporated. As shown, the system 100 includes a subscriber device 102 that communicates with a base station device 104 for access to a switching element 106. The switching element 106 is connected to and communicates with a network 108. Various elements can be accessed through the network 108 including a profile server 120, a podcast server 130 and a location-based services (LBS) server 140. It should be appreciated that the system 100 may take a variety of forms according to the presently described embodiments and that the system 100 is merely shown as an example.

Likewise, the elements illustrated in the example system 100 may take a variety of forms that are suitable to implement the presently described embodiments. For example, the subscriber device 102 may take the form of a suitable mobile device such as a mobile phone, personal mobile device, PDA, mini-computer, smart phone, pager, or any like device that may be carried by a subscriber from location to location. In some forms, the subscriber device 102 may also comprise and/or be connected to and in communication with a vehicle audio player through a satellite source or over a suitable WiFi connection such as Blue Tooth and Blue Tooth over 802.11 for source and receive. It should be appreciated that the subscriber device 102 may also be a mobile component of an In-Building (IB) system for audio playback systems such as walking tour systems and the like. It will be appreciated that the subscriber device 102 may also be operative to receive throttled delivery of content or podcast information to playback based on sub-perimeters, sublocations or zones of, for example, a gallery, a building's wing, forks in a hiking trail . . . etc, as noted above. This throttled delivery may even re-start based on the tags associated within sub-perimeters, sub-locations or zones. The subscriber device will, in some forms, also be operative to achieve these features using a manually invokable, or user specified, table of content or the like.

Base station 104 may also take on a variety of suitable forms as a function of applicable protocols or the generation of network technology that is implemented. For example, in addition to a conventional base station, it may take the form of an eNode-B, a femto-cell, a wireless router, or a WiFi router. Notwithstanding the precise form and overall functionality, any suitable device operating as, or in place of, base station 104 to provide communication between a subscriber device 102 and switching element 106 will suffice.

The switching element 106 may also take a variety of forms. It will be appreciated that the switching element has different monikers and names in various technologies and generations of technologies. Any such switching elements are contemplated to be suitable for use with the presently described embodiments. For example, the switching element 106 may function in a variety of protocols including IP, CDMA, 3G 1x-data, EVDOeHRPD, LTE, UMTS, GSM, WiMax, and/or WiFi.

Likewise, the LBS server 140 may take a variety of forms that are suitable for communication based on the configuration and/or protocols of the network. In at least one form, the LBS server is operative to provide a calculation of subscriber location (e.g. latitude/longitude/altitude). In at least one form, mapping information, including three-dimensional mapping information, may be provided by the LBS server for ultimate viewing by the subscriber. Of course, if an LBS server 140 is not available, location information may be alternatively determined in the system via Global Positioning System (GPS) handset or hardware device—in both the wireless macro-systems as well as for IB In-building systems. In addition, as an alternative, cell site trilaterated-location information may be utilized.

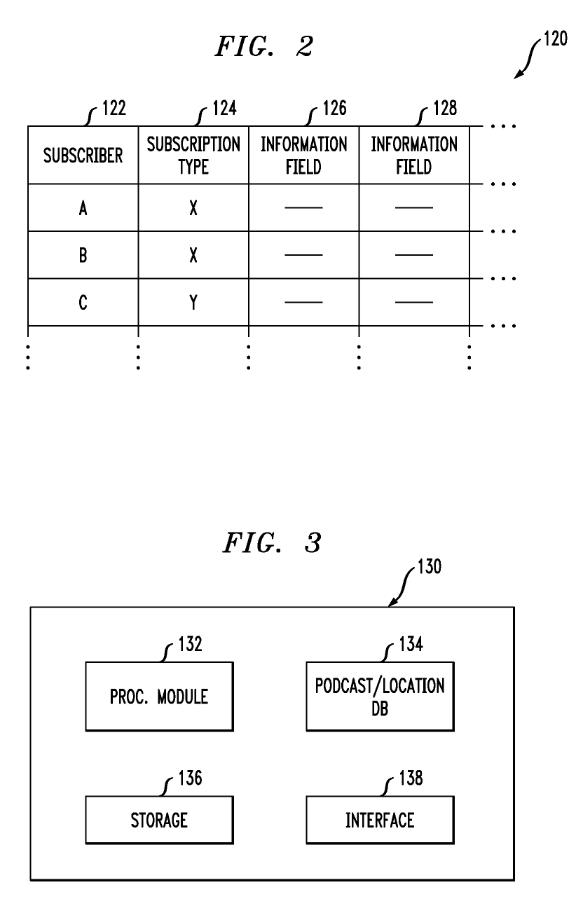

With reference to FIG. 2, it should be appreciated that profile server 120 may take a variety of forms and, in some forms, the application for configuration of the server may be internet or web-based. In one form, FIG. 2 shows that the profile server 120 will include storage modules that allow for storage of at least user information 122 and subscription-type information 124. These fields will allow for a convenient validation of a subscriber after such subscriber makes a request for service. It should be appreciated that storage of the retrieval media itself (e.g. the podcast information) may be accomplished in an integrated manner in a variety of environments within the system; however, in one form, the media is stored in the podcast server 130 in, for example, a storage module as will be described in connection with FIG. 3.

Referring back to FIG. 2, in at least one form, an application for individual customization or configuration (e.g. self-customization) of the subscriber profile may be provided. The profile server may store profiles by subscriber, as shown. The information may also include, and be categorized by, other information provided by the subscriber and stored in fields (such as information or preference fields 126, 128, . . . etc.) within the profile server 120. This additional information may include subscriber class or Quality of Service (QoS) information on desired Podcast information content. “Coded” criteria may also be used in the profiles.

Further, the individual profile may be populated (e.g. in information fields such as fields 126, 128, . . . etc.) with subscriber interests and other information such as a desired radius from a current location for which geolocation (and temporal) network information will be provided. The profile information may also include a maximum data download size for the podcast information or a maximum number of database selections. Several other such profile variables customizing the individual subscriber experience are also possible as elaborated in various embodiments elsewhere herein.

The profile server 120 may include other functionality to enhance the core network Podcast functionality. For example, the customization may include temporal information such as applicable timeframes. Thus, the system will be aware of not only the desired podcast information, but also the times when this information may be of interest to the subscriber. Subscribers may specify (e.g. within the noted preference fields), in advance, both location and time for delivering and playing podcast information. For example, a subscriber may specify that the subscriber will be in a place at a particular time (e.g. Florence, Italy, two months from now, or, at the Fox River Valley Art Festival this week-end). This information will then trigger the system to conduct a search or retrieve suitable data when the time and place criteria are realized by the subscriber. In one form, the podcast server (e.g. through its processing module and corresponding routines) is operative to use this information to provide service to the subscriber in the desired circumstances, or potentially in advance of an event the subscriber is anticipating, if available.

The profile server 120 may utilize the information fields illustrated to maintain multiple interest profiles for the subscribers or users. For example, a user may have several profiles stored based on various criteria. For example, multiple profiles based on size of, or amount of information in, the profiles may be maintained. In this manner, tiered profiles may be implemented. In one case, a first profile, or tier, may be smaller and more focused than a second profile, or tier, which is smaller and more focused than a third profile, or tier. In another variation, genre-based profiles may be maintained for a user. In one form, a user may have a first profile based on an interest in tourism, a second profile based on an interest in learning, a third profile based on an interest in athletics, . . . etc. The selection of a profile for a user may be accomplished in a variety of manners. For example, the user may manually designate a profile for use in retrieving podcast information, or a profile may be selected based on criteria set by the user such as time (or temporal information) or location and stored in the information fields.

The system may also be configured to provide the option of a profile default or default profile. In at least one form, such a default profile would not be configured by specific subscribers based on their personal interests, but populated by a network routine that assesses past searches of similarly situated subscribers. Such similarly situated subscribers may be subscribers having similar geographic coordinates. The default profiles may be suggested to subscribers by the network on an automated (or spontaneous to the user) basis or at the request of the subscriber. It should be appreciated that, even though such default profiles are not contemplated to be configurable by individual subscribers, individual subscribers may nonetheless be provided with some opportunity to control or filter the suggestion by the system of default profiles. For example, an individual subscriber may request that default profiles on athletic topics or genres never be suggested.

The profile defaults could be implemented by any appropriate combination of the profile server 120, podcast server 130 at LBS server 140, or other suitable network components. These default profiles may be populated or updated on an on-going basis, or on an on-demand basis.

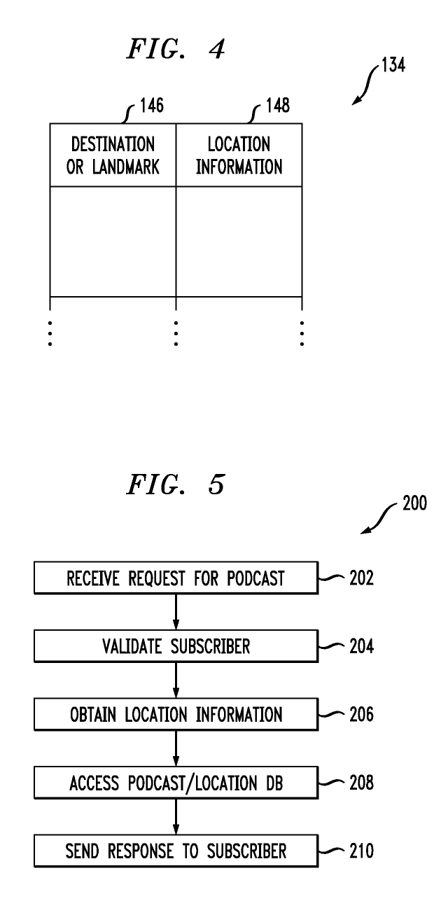

The podcast server 130 may also take on a variety of forms. At least one of these forms is illustrated in FIG. 3. As shown, the podcast server 130 includes a processing module 132 for processing requests and performing other necessary functionality to implement the presently described embodiments, a podcast/location database 134 (described in connection with FIG. 4), a podcast information storage module 136 for storing podcast information retrieved during the process and an interface module 138 operative to receive and provide information during the process. It should be appreciated that the podcast information storage module 136 may take various forms and, in some forms, the module or portions thereof may be located in different locations to accommodate its function. For example, it may be used to buffer podcast information retrieved from another location for playback or forwarding purposes or used to store podcast information on a longer term basis (e.g, wherein it may be established as a location to store podcast information for various entities).

It should be appreciated that modules of the podcast server 130 may be implemented in a variety of manners using suitable software routines and/or hardware configurations. In some forms, certain customizable options, criteria, and/or threshold limits will be implemented by the podcast server 130. These functions may include calculation of available content within a specified radius (e.g. in miles or kilometers from the current, or otherwise specified in advance, location), designation of a maximum data download size, identification of a content type or “code,” implementation of a threshold relating to the number of IP selections to be offered for download, or implementation of criteria (e.g. location and time) to be used in searching and/or retrieving podcast information.

With reference to FIG. 4, the podcast/location database 134 is illustrated. As shown, the podcast/location database 134 includes a destination point or landmark field 146 for which podcast information is available and a location information field 148. This relational database will allow a user in a specified geographic location to conveniently access local information podcasts or podcast information for delivery to the user device. In this regard, podcast information may be associated with notable landmarks, historic sites, community interest Public Relations, Public Safety, parks, recreational rest areas, beaches, golf courses, campsites, national park hiking trail narrations, tourist travel look-out vistas, sports arenas, concert venues, restaurants, and related “trailers” available possibly for subsequent “premium” content download. In-Building (IB) applications might include museums, art galleries, or historic site self-guided tour narrations.

It should be appreciated that this selection of location-specific podcast information (e.g. pre-recorded or real-time) with lat/long/alt telemetry coordinates may be provided by a variety of sources. In one form, the podcasts or podcast information will typically be created by various non-profit (and for-profit) enterprises or government sector agencies and may be stored in various locations that can be accessed by the system, including storage modules such as storage module 136 or other storage areas such as those controlled by the entities creating the podcast information. For example, this information may be provided by Tourist Bureau's, museums, or any of a large number of varying sources. The podcast information, e.g. pre-recorded or real-time media, may be made sensitive to sub-perimeter, sub-location or zone delivery by locating or inserting tags in the podcast information. The tags may then be correlated within a defined map related to the podcast information. Additionally, in one form, periodic updates of the location of the subscriber may be performed to assure that the subscriber receives appropriate content. Alternatively, a table of content, manually invoked by the user, may be used and, in one form, may default or override the aforementioned automated approach. In at least one form, the system, e.g. the podcast server, the processing module, and/or the subscriber device, is operative to recognize these tags (or location triggers) within the podcast information so that relevant portions of the podcast information are provided to the subscriber when the subscriber enters the location identified by the tag.

With reference to FIG. 5, a method according to the presently described embodiments is shown. The method 200 may be implemented in a variety of manners using suitable software routines and/or hardware configurations. The implementation of the method may be provided on the podcast server 130 or at other locations in the network including other application servers dedicated to implementation of this and other functionality.

As shown, the method 200 is initiated by a request for podcast information (at 202) that is sent by a subscriber device 102 through base station 104, switching element 106 and through the network 108. The process may also be initiated by the network for a particular subscriber device. In such a case, the request may be generated by the network or the subscriber device. The request is thus received by the podcast server 130 (through, e.g. the interface 138) in at least one form of the presently described embodiments (at 202). It should be appreciated that a traditional subscriber profile in a subscriber database associated with the switching element 106 may include a field in which to set a flag or indicator indicating that the subscriber indeed subscribes to the contemplated podcast service. In this way, switching element 106 has sufficient knowledge to forward the request for podcast information to the podcast server 130 to initiate the presently described embodiments, for the purpose, for example, of monetization of the service to podcast applications. Also, it should be appreciated that the request for podcast information may be, in reality, a request for delayed response either temporally or geographically. That is, as mentioned above, the user may send a request for podcast information for a specified time (e.g. a future time) or upon entry into a specified geographic location in the future.

Once the request for podcast information is received by the podcast server, the server verifies the validity of the subscriber device by accessing the profile server 120 (at 204). This can be accomplished in a variety of known manners, including through use of the processing module 132 of the podcast server 130. If the subscriber device is determined to be invalid, a rejection message will simply be sent back to the subscriber.

If, however, the subscriber device is valid, the process proceeds to provide the requested information. In at least one form, the subscriber profile information is provided to the podcast server for further processing by, for example, the processing module 132. It should be appreciated that the subscriber may be presented with options on which profile to select, if more than one profile (as described above, for example) is available for the user through, for example, the interface 138.

In any event, after a subscriber device is validated, location information for the subscriber is then obtained by the podcast server by using the LBS server 140 (at 206). The location information may take a variety of forms and may also include mapping information (including three-dimensional mapping information) for ultimate viewing by the subscriber. As noted above, if an LBS server is not used or available, other location information such as suitable GPS-type information or cell site trilaterated information may be obtained to provide the subscriber location.

Once the location of the subscriber is determined, the podcast server accesses its podcast/location database 134 to determine the podcast information available for geographically local landmarks and/or destinations (at 208). In this way, the location information is matched to data in the database and correlated to landmarks or destinations for which podcast information is available. Other profile information may also be accessed and used to determine which podcast information will be provided to the subscriber, or how it will be presented, filtered prior to delivery and/or delivered. Other preferences such as monetization, adjunct SMS, information-sharing, interactive “social media-like” application interfaces, . . . etc. may also be utilized. For example, the interests and preferences of a subscriber may be used to filter out some of the available podcasts. A response, including this information, is then sent to the subscriber (at 210). The podcast information may also be retrieved and forwarded to the subscriber, either automatically or upon election by the subscriber (in, for example, cases where multiple podcasts are available). Of course, other information, such as mapping information, may also be forwarded to the subscriber for use or viewing purposes. In at least one form, the podcast information that is ultimately forwarded to the subscriber is stored in the storage module 136 so that it can be conveniently forwarded to the subscriber for playback. In this regard, in at least one form, the podcast information is staged for playback in the storage module, which is particularly useful where the podcast information includes tags for triggering selective playback when the subscriber enters specified locations.

It should also be appreciated that the subscriber may elect to defeat or ignore his/her profile, or preferences, and initiate other functionality, such as an override, pause delivery function (for example, to use other functionality on the subscriber device), an edit function or a searching function. In this regard, the user may be presented with an appropriate list of options through the user interface of the device of the user. Using this functionality, the user may be permitted to edit preferences or profile information (in, for example, the information fields noted above) on a permanent or temporary basis to locate other podcast information, filter retrieved podcast information, or refine the search for podcast information. If the searching function is desired by the user, a search box may be presented to the user to conduct further searching for desirable podcasts. It should be appreciated that such searching may be tailored to retrieval of audio or podcast-type information, or the searching could simply be conventional web searching.

The presently described embodiments implement various technologies to offer subscribers a variety of enhanced and germane content. The contemplated systems and techniques use the assistance of a geographically and temporally aware network and a configurable relational database profile of interests and parameters. Subscribers are spatially and temporally enabled by an intelligent network to obtain a host of individually customizable podcast information. Subscribers are freed from determining a sometimes elusive association between their location and available information. An open delivery format may also be provided, whereby all profiles and filters are intentionally optionally defeated by the user, in order for the user to freely engage curiosity of new potentially unknown media content. The network intelligence would simply offer a full range of proximate content under such criteria.

Wireless Network technologies used in connection with the presently described embodiments may include, but are not limited to: IP, CDMA, UMTS, WiMax, WiFi, femto, Satellite Radio, & LTE/IMS. Interfacing technologies are involved from devices accessing this network awareness, to other consumer devices. A collaborative applications development ecosystem partnership platform may additionally be provided by NE Network Element infrastructure vendors.

In addition, device menu functionalities (wireless handsets, WiFi-enabled personal music/media devices like iPod's), as well as related protocols, are involved. For example, Navigation GPS hardware/software, DVD/VHS/hard-drive playback units, Bluetooth, femto, and other interface and data sync mechanisms may be used as adjuncts in the system.

Various P2P (peer-to-peer) integrated interactive applications/functions are envisioned to enrich the core podcast information/media sources. Such interfaces for the contemplated application will allow for a subscriber to share information (e.g. “I enjoyed my time so much more while in Florence, Italy as a result of the Podcast content I planned in advance, I want to share, rate, vote, blog, wiki, or recommend to buddies.”).

It should be appreciated that subscriber content access facilitating functionality may be realized by various means, such as ala carte, pay-as-you-go, subscription service premium “trailer” data, or could simply be included among a bundle of other potentially monetized data services.

The advantages of the presently described embodiments are many. For example, there is time savings for a subscriber using the presently described embodiments. Also, proximity and location information allow for the efficient retrieval of germane information that is presently desired. Creative inquiry is also enhanced because content varies by location and time, and as delivered by an enhanced intelligent and aware network.

The presently described embodiments may be implemented in a variety of circumstances and environments. For example, in one form of this solution, mobile telecom network subscribers are envisioned on vacation, or otherwise mobile, passing a landmark or entering a city, etc. Upon observing something of interest (e.g. a windmill), the subscribers check to see if podcast information is available based on their location. Selections are offered from the database, e.g., about this windmill. In this example, podcast information may have been provided to the Service Provider by a village, as a matter of community interest Public Relations, and/or tourism.

Another embodiment of this solution envisions podcast information, interfaced from the telecom network subscriber handset to, for example, the backseat of a mini-van. A DVD/VHS player, hard-drive unit receives the data via cable, mobile femto cell, Bluetooth, consumer personal networking technologies, etc. The system then allows playback for multiple passengers for education, public safety, and/or entertainment purposes.

Yet another embodiment envisions museum goers, art gallery patrons, historical site visitors, hikers at national parks, metropolitan area tourists, etc., obtaining a variety of self-guided narrated tours. This embodiment replaces, in some cases, older technologies—like a cassette player and headphone provided for a narrated tour of the galleries at an art museum.

A person of skill in the art would readily recognize that steps of various above-described methods can be performed by programmed computers. Herein, some embodiments are also intended to cover program storage devices, e.g. digital data storage media, which are machine or computer readable and encode machine-executable or computer-executable programs of instructions, wherein said instructions perform some or all of the steps of said above-described methods. The program storage devices may be, e.g. digital memories, magnetic storage media such as a magnetic disks and magnetic tapes, hard drives, or optically readable digital data storage media. The embodiments are also intended to cover computers programmed to perform said steps of the above-described methods. Several current (long-distant) communications transport technologies, both wireless as well as wired and optical, etc., including microwave, may also typically become involved in upstream content delivery, prior to the last leg delivery to the subscriber.

The functions of the various elements shown in the figures, including any functional blocks labeled as “processors,” may be provide through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context. Related technologies are numerous in this networked application and are continuously evolving.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for providing podcast information to a subscriber device at specific geographical locations at the request of a subscriber or network, the system comprising:
a podcast server operative to receive a request from the subscriber or network to provide podcast information to the subscriber device, validate the subscriber device, obtain location information for the subscriber device, and provide the podcast information to the subscriber device based on the location information.

2. The system as set forth in claim 1 further comprising a profile server operative to store subscriber information access by the podcast server.

3. The system as set forth in claim 2 wherein the subscriber information comprises subscriber preferences.

4. The system as set forth in claim 1 further comprising a location-based services server operative to provide requested location information to the podcast server.

5. The system as set forth in claim 4 wherein the location information comprises mapping information provided to the subscriber device for viewing.

6. The system as set forth in claim 5 wherein the mapping information is three-dimensional mapping information.

7. The system as set forth in claim 1 wherein the podcast server comprises a relational database including information on destination points and corresponding location information on the destination points.

8. The system as set forth in claim 1 wherein the podcast server comprises a podcast storage module having stored therein podcast data.

9. The system as set forth in claim 1 wherein the podcast server comprises an interface module operative to allow at least one of short message communications, information sharing, subscriber voting, blogging, and interaction with other subscribers.

10. The system as set forth in claim 1 wherein the podcast server is further operative to provide the podcast information to the subscriber device based on temporal information.

11. A system for providing podcast information to a subscriber device at specific geographical locations at the request of subscriber, the system comprising:
means for receiving a request from the subscriber device to provide podcast information to the subscriber device;
means for validating the subscriber device;
means for obtaining location information for the subscriber device; and, means for providing podcast information to the subscriber device based on the location information.

12. A method for providing podcast information to a subscriber device at specific geographical locations at the request of subscriber, the method comprising:
receiving a request from the subscriber device to provide podcast information to the subscriber device;
validating the subscriber device;
obtaining location information for the subscriber device; and, providing podcast information to the subscriber device based on the location information.

13. The method as set forth in claim 12 further comprising sending the request from the subscriber device.

14. The method as set forth in claim 12 wherein the subscriber device is one of a mobile phone, personal mobile device, FDA, mini-computer, smart phone, or pager.

15. The method as set forth in claim 12 wherein the validating comprises accessing a podcast profile server.

16. The method as set forth in claim 12 wherein the obtaining of location information comprises accessing a location based services (LBS) server.

17. The method as set forth in claim 12 wherein the obtaining of location information comprises using at least one of Global Positioning System (GPS) information, or LBS determination using trilateration between cell sites.

18. The method as set forth in claim 12 wherein the providing of the podcast information comprises accessing a database having stored therein podcast information and corresponding location information.

19. The method as set forth in claim 12 wherein providing the podcast information to the subscriber device is further based on temporal information.

20. The method as set forth in claim 12 wherein providing content based on the location information comprises delivering content upon detection of the subscriber device in a selected sub-location, wherein the sub-location is tagged for such delivery or defined in a user specified table.
